(19) United States
(12) Patent Application Publication
(10) Pub. No.: US 2007/0232225 A1
(43) Pub. Date: Oct. 4, 2007

(54) Mobile terminal apparatus, server apparatus and broadcast play system

(75) Inventor: Daisuke Kikuchi, Yokohama-shi (JP)

Correspondence Address: MICHAUD-DUFFY GROUP LLP, 306 INDUSTRIAL PARK ROAD, SUITE 206, MIDDLETOWN, CT, 06457, US

(73) Assignee: NTT DoCoMo, Inc., Tokyo (JP)

(21) Appl. No.: 11/728,888

(22) Filed: Mar. 27, 2007

(30) Foreign Application Priority Data
Mar. 30, 2006 (JP) 2006-093182

(51) Int. Cl. H04H 7/00

(52) U.S. Cl. 455/3.06

(57) ABSTRACT

Provided are a broadcast receiving section that receives a broadcast program distributed from a broadcast station, a picture play section that plays pictures of the broadcast program, and a data communication section that communicates with a server via a communication channel, where when a play of pictures of the broadcast program is interrupted, TS/CH information is transmitted to the server, a TS list generated based on the TS/CH information is received from the server, a play of the broadcast program is requested to the server when receiving selection of the broadcast program of which play is desired among the play interruption program list from the user, and pictures of the broadcast program transmitted from the server corresponding to the play request is played in the picture play section.

### CROSS-REFERENCE TO RELATED APPLICATION

The present disclosure relates to subject matters contained in Japanese Patent Application No. 2006-093182 filed on Mar. 30, 2006, which is expressly incorporated herein by reference in its entirety.

### BACKGROUND OF THE INVENTION

1. Field of the Invention

The present invention relates to a mobile terminal apparatus, server apparatus and broadcast play system, and more particularly, to a mobile terminal apparatus, server apparatus and broadcast play system suitable for playing a broadcast program distributed from a broadcast station.

2. Description of the Prior Art

In Recent years, mobile terminal apparatuses (hereinafter, referred to as “mobile terminals”) have been in the marketplace, for example, in the form of cellular telephones and the like enabling the watching of broadcast programs distributed from broadcast stations. In the mobile terminals, watching a program is assured within a zone of broadcast of radio signals, but when the mobile terminal moves out of the zone of broadcast radio signals, watching of the program is interrupted due to poor, or lost signal. In order to cope with such an interruption, a mobile terminal (digital broadcast reception cellular terminal apparatus) and server apparatus (program distribution station) are proposed which enable watching of the program from a portion interrupted outside the home even when an interruption of watching of the program occurs due to inability to receive broadcast radio signals (for example, JP 2004-274562). In this mobile terminal, when detecting an interruption of reception of broadcast radio signals, the mobile terminal transmits broadcast reception interruption time and watched program information to the server apparatus, the server apparatus distributes data of moving pictures from the interrupted portion of the broadcast program, and it is thus made possible to watch the broadcast program from the interrupted portion.

However, in the aforementioned conventional mobile terminals and the like, when the terminal is moved back into the zone of broadcast radio signals, the server apparatus automatically distributes data of moving pictures from the interrupted portion of the broadcast program at the time the terminal comes back, and there arises a problem adversely interfering with watching of a broadcast program that is currently being broadcast.

In particular, when all the video data pertaining to a program of wherein watching was interrupted is distributed at the time when the terminal is moved back into the zone, since an actually unnecessary program is also distributed via communication, a problem occurs that loads on the server are large.

Further, in the conventional mobile terminals and the like, a subject of distribution is only the data of moving pictures of a broadcast program of which watching is interrupted when the terminal moves out of the zone of broadcast radio signals. However, there is a current need for user of mobile terminals, to be able to watch a broadcast program after temporarily halting watching of the broadcast program even when still inside the zone.

### SUMMARY OF THE INVENTION

It is an object of the invention to provide a mobile terminal apparatus, server apparatus and broadcast play system enabling the watching of pictures of a broadcast program that the user desires among pictures of the broadcast program of which watching is interrupted, while reducing loads on the server apparatus without inhibiting watching of a currently watched broadcast program.

A mobile terminal apparatus of the invention is a mobile terminal apparatus connected via a communication channel to a server apparatus that stores pictures of a broadcast program distributed from a broadcast station, and has a broadcast receiving section that receives a broadcast program distributed from a broadcast station, a picture play section that plays pictures of the broadcast program, and a communication section that communicates with the server apparatus via the communication channel. When the playing of pictures or video is interrupted, the terminal apparatus transmits interruption time information and program specific information to the server apparatus. The terminal apparatus receives a play interruption program list generated based on the interruption time information and program specific information, requests a play of the broadcast program to the server apparatus when receiving selection of the broadcast program of which play is desired among the play interruption program list, and plays in the picture play section pictures of the broadcast program transmitted from the server apparatus corresponding to the play request.

According to this embodiment, when a play of pictures of a broadcast program is interrupted, the interruption time information and program specific information is transmitted to the server apparatus, and the server apparatus generates a play interruption program list based on the interruption time information and program specific information to transmit to the mobile terminal apparatus. When receiving a selection of a broadcast program that the user desires to play among the play interruption program list, a play requested in made to the server apparatus, and pictures of the broadcast program transmitted from the server apparatus corresponding to the play request are played in the mobile terminal apparatus. Therefore, since pictures of the broadcast program are transmitted corresponding to the timing at which the user selects the broadcast program from the play interruption program list, it is possible to transmit the pictures of the broadcast program that the user desires without inhibiting a broadcast program currently being watched. Further, since only the pictures of the broadcast program selected from the play interruption program list are transmitted from the server apparatus, it is possible to transmit the pictures of the broadcast program that the user desires while reducing loads on the server apparatus. Furthermore, since reasons for an interruption of a broadcast program are not limited to reasons caused by conditions of broadcast radio signals, a user is allowed to watch pictures of the broadcast program that the user desires among pictures of the broadcast program of which watching is interrupted corresponding to any interruption reason.

The mobile terminal apparatus of the invention further has an instruction input section that receives an interruption instruction for the play of the broadcast program, and may transmit the interruption time information and program specific information to the server apparatus when receiving the interruption instruction for the play of the broadcast program via the instruction input section. In this case, the interruption time information and program specific information is transmitted to the server apparatus corresponding to the interruption instruction for a play of the broadcast program, the play interruption program list is generated based on the interruption time information and the like, and it is thereby possible to interrupt watching of the program at a desired time by a user of the mobile terminal apparatus. The interrupted broadcast program can then be viewed at a later time chosen by the user.

The mobile terminal apparatus of the invention further has a radio-signal condition detecting section that detects a condition of a radio signal from the broadcast station, and may transmit the interruption time information and program specific information to the server apparatus corresponding to a detection result of the condition of the radio signal by the radio-signal condition detecting section. In this case, the interruption time information and program specific information is transmitted to the server apparatus corresponding to the detection result of the condition of the radio signal (for example, out of the zone or within the zone), the play interruption program list is generated based on the interruption time information and the like, and it is thereby possible to watch pictures of the interrupted broadcast program later even when watching of the program is interrupted corresponding to the condition of the broadcast radio signal.

The mobile terminal apparatus of the invention further has an open/closed state detecting section that detects an open/closed state of a main body of the terminal, and may transmit the interruption time information and program specific information to the server apparatus corresponding to a detection result of the open/closed state by the open/closed state detecting section. In this case, the interruption time information and program specific information is transmitted to the server apparatus corresponding to the detection result of the open/closed state of the mobile terminal apparatus, and it is thereby possible to judge an interruption of watching of the program corresponding to the open/closed state of the mobile terminal apparatus and generate a play interruption program list corresponding to the judgment

In addition, in the mobile terminal apparatus of the invention, it is preferable that the interruption time information is formed of interruption start time information to start an interruption of the play of the broadcast program and interruption termination time information to terminate the interruption of the play of the broadcast program. In this case, the broadcast program such that watching of the program is interrupted is specified from the interruption start time information and interruption termination time information, and it is thereby possible to specify the broadcast program with ease

The mobile terminal apparatus of the invention further has an elapsed time monitoring section that monitors an elapsed time between the interruption start time information and interruption termination time information, and the elapsed time monitoring section automatically may designate the interruption termination time information when the elapsed time exceeds a predetermined time. In this case, since the interruption termination time information is designated automatically when the elapsed time exceeds a predetermined time from the interruption start time information, for example, when a user forgets to release an interruption after instructing the interruption of watching of the program, it is possible to prevent the occurrence of continuation of the interruption of watching of the program

A server apparatus of the invention is a server apparatus connected via a communication channel to a mobile terminal apparatus that plays pictures of a broadcast program distributed from a broadcast station, and has a broadcast receiving section that receives a broadcast program distributed from the broadcast station, a picture storing section that stores pictures of the broadcast program, a communication section that communicates with the mobile terminal apparatus via the communication channel, a storing section that stores interruption time information and program specific information that is transmitted when a play of pictures of the broadcast program is interrupted in the mobile terminal apparatus, a list generating section that generates a play interruption program list based on the interruption time information and program specific information, and a picture acquiring section that acquires pictures of the broadcast program selected from the play interruption program list from the picture storing section, where the server apparatus generates and transmits the play interruption program list corresponding to a request from the mobile terminal apparatus, and when receiving selection of the broadcast program of which play is desired among the play interruption program list, acquires pictures of the broadcast program from the picture storing section to transmit to the mobile terminal apparatus.

According to this embodiment, the play interruption program list is generated and then transmitted corresponding to a request from the mobile terminal apparatus, and when receiving a selection of a broadcast program of which play is desired among the play interruption program list, pictures of the broadcast program are acquired from the picture storing section and transmitted to the mobile terminal apparatus. Therefore, since pictures of the broadcast program are transmitted corresponding to the timing at which the user selects the broadcast program from the play interruption program list, it is possible to transmit pictures of the broadcast program that the user desires, without inhibiting watching of a currently broadcast program. Further, since the pictures of the broadcast program selected from the play interruption program list are transmitted from the server apparatus, it is possible to transmit pictures of the broadcast program that the user desires while reducing loads on the server apparatus. Furthermore, since reasons for an interruption of a broadcast program are not limited to reasons caused by conditions of broadcast radio signals, a user is allowed to watch pictures of the broadcast program that the user desires among pictures of the broadcast program of which watching is interrupted corresponding to any interruption reason.

In the server apparatus of the invention, the interruption time information is formed of interruption start time information to start an interruption of the play of the broadcast program and interruption termination time information to terminate the interruption of the play of the broadcast program, and the picture acquiring section may acquire pictures of the broadcast program specified by the interruption start time information and interruption termination time information among pictures of the broadcast program stored in the picture storing section. In this case, the broadcast program such that watching of the program is interrupted is specified from the interruption start time information and interruption termination time information, and it is thereby possible to specify the broadcast program with ease.

A broadcast play system of the invention is a broadcast play system comprised of a mobile terminal apparatus that receives a broadcast program distributed from a broadcast station while playing pictures of the broadcast program, and a server apparatus which is connected to the mobile terminal apparatus via a communication channel, and receives a broadcast program distributed from the broadcast station while storing pictures of the broadcast program, where the mobile terminal apparatus transmits interruption time information and program specific information to the server apparatus when a play of pictures of the broadcast program is interrupted, the server apparatus transmits to the mobile terminal apparatus a play interruption program list generated based on the interruption time information and program specific information, the mobile terminal apparatus requests a play of the broadcast program to the server apparatus when receiving selection of the broadcast program of which play is desired among the play interruption program list, the server apparatus acquires pictures of the broadcast program of which play is requested from stored pictures of the broadcast program to transmit to the mobile terminal apparatus, and the mobile terminal apparatus plays the pictures of the broadcast program.

According to this embodiment, when a play of pictures of a broadcast program is interrupted, the interruption time information and program specific information is transmitted to the server apparatus, and the server apparatus generates a play interruption program list based on the interruption time information and program specific information to transmit to the mobile terminal apparatus. When receiving selection of a broadcast program that the user desires to play among the play interruption program list, a play of the broadcast program is requested to the server apparatus, and pictures of the broadcast program transmitted from the server apparatus corresponding to the play request are played in the mobile terminal apparatus. Therefore, since pictures of the broadcast program are transmitted corresponding to the timing at which the user selects the broadcast program from the play interruption program list, it is possible to transmit the pictures of the broadcast program that the user desires, without inhibiting watching of a currently watched broadcast program. Further, since only the pictures of the broadcast program selected from the play interruption program list are transmitted from the server apparatus, it is possible to transmit the pictures of the broadcast program that the user desires while reducing loads on the server apparatus. Furthermore, since reasons for an interruption of a broadcast program are not limited to reasons caused by conditions of broadcast radio signals, a user is allowed to watch pictures of the broadcast program that the user desires among pictures of the broadcast program of which watching is interrupted corresponding to any interruption reason.

### BRIEF DESCRIPTION OF THE DRAWINGS

The various features of novelty which characterize the invention are pointed out with particularity in the claims attached to and forming a part of this specification. For a better understanding of the invention, its operating advantages, and specific objects attained by its use, reference should be had to the accompanying drawing and descriptive matter in which there is illustrated and described a preferred embodiment of the invention.

FIG. 1 is a diagram to explain a configuration of a network to which is applied a broadcast play system according to a first embodiment of the invention;

FIG. 2 is a diagram illustrating a schematic configuration of a mobile terminal according to the first embodiment;

FIG. 3 is a diagram illustrating a schematic configuration of a server apparatus according to the first embodiment;

FIG. 4 is a sequence diagram to explain operation in a case of interrupting watching of a broadcast program and playing the interrupted portion later in the mobile terminal in the broadcast play system according to the first embodiment;

FIG. 5 is a table showing an example of TS/CH information registered with a storing section of the server apparatus of the first embodiment;

FIG. 6 is a table showing an example of a TS list displayed in a display section of the mobile terminal according to the first embodiment;

FIG. 7 is a diagram to explain operation timing of each structural element in the case of interrupting watching of a broadcast program in the mobile terminal according to the first embodiment;

FIG. 8 is another diagram to explain operation timing of each structural element in the case of interrupting watching of a broadcast program in the mobile terminal according to the first embodiment;

FIG. 9 is a table showing an example of a modification of the TS list displayed in the display section according to the first embodiment;

FIG. 10 is another diagram to explain operation timing of each structural element in the case of interrupting watching of a broadcast program in the mobile terminal according to the first embodiment;

FIG. 11 is a diagram illustrating a schematic configuration of a mobile terminal according to a second embodiment of the invention;

FIG. 12 is a diagram to explain operation timing of each structural element in the case of interrupting watching of a broadcast program in the mobile terminal according to the second embodiment;

FIG. 13 is a diagram illustrating a schematic configuration of a mobile terminal according to a third embodiment of the invention; and

FIG. 14 is a diagram to explain operation timing of each structural element in the case of interrupting watching of a broadcast program in the mobile terminal according to the third embodiment.

### DESCRIPTION OF THE PREFERRED EMBODIMENTS

Embodiments of the invention will specifically be described below with reference to accompanying drawings.

### First Embodiment

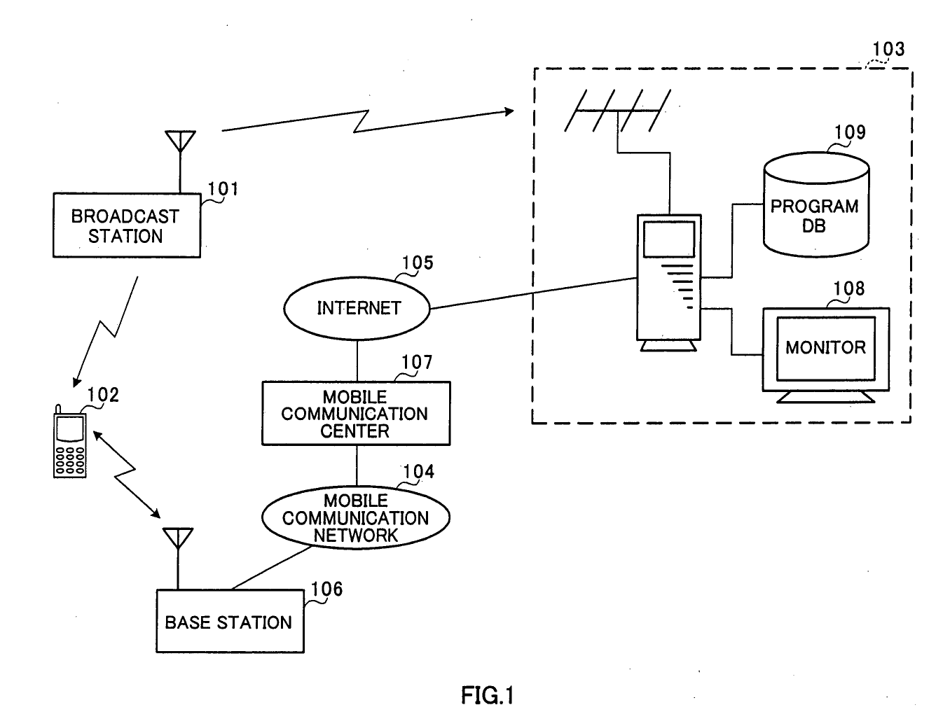

FIG. 1 is a diagram to explain a configuration of a network to which is applied a broadcast play system according to a first embodiment of the invention. As shown in FIG. 1, the broadcast play system according to this embodiment has a broadcast station 101 that distributes broadcast programs, a mobile terminal 102 that performs mainly reception and play of distributed broadcast programs, and a content server apparatus (hereafter, referred to as a “server”) 103 that performs mainly reception and storage (record) of distributed broadcast programs.

The mobile terminal 102 is configured to be able to gain access to the server 103 via a mobile communication network 104 comprised of a communication network such as a PDC-P (Personal Digital Cellular-Packet) network and a communication network such as the Internet 105. As described later, the mobile terminal 102 is capable of receiving part (or all) of pictures of broadcast programs registered with the server 103 via such communication networks. At this point, the mobile terminal 102 communicates with a nearest base station 106 installed on the mobile communication network 104, and further communicates with the server 103 via the mobile communication network 104 and Internet 105.

The mobile communication network 104 is connected to a mobile communication center 107. The mobile communication center 107 is connected to other terminal apparatuses such as personal computers (PC) and the like via the Internet 105, and has the gateway function of connecting the mobile terminal network 104 and Internet 105. More specifically, the center 107 has the information distribution function, mail transmission/reception function, mail storage function, contract customer management function, information provider management function and information fee charging function.

The broadcast station 101 distributes broadcast programs provided using digital terrestrial broadcasting, for example. The broadcast programs distributed from the broadcast station 101 are received not only in a fixed television set in the home, but also in the mobile terminal 102 and server 103 installed with the digital terrestrial broadcasting reception function.

The mobile terminal 102 is installed with the digital terrestrial broadcasting reception function, and capable of receiving a broadcast program distributed from the broadcast station 101 to play (watch). Further, the mobile terminal 102 temporarily interrupts watching of a broadcast program being played, and to enable pictures of interrupted part to be watched later, transmits time stamp information (hereinafter, referred to as “TS information”) corresponding to the interruption time information and channel information (hereinafter, referred to as “CH information”) corresponding to the program specific information to the server 103. Further, the terminal 102 selects pictures of the broadcast program of which watching is interrupted based on a time stamp list (hereinafter, referred to as a “TS list” as appropriate) corresponding to the play interruption program list transmitted from the server apparatus 103, and is capable of playing the pictures of the broadcast program transmitted from the server 103 in response to the selection.

The server 103 is installed with the digital terrestrial broadcasting reception function, and capable of receiving all the broadcast programs distributed from the broadcast station 101 to register with a program database (hereinafter, referred to as a “program DB”) 109. In other words, with the program DB 109 are registered broadcast programs of all the channels of all the time periods received in the server 103. Further, the server 103 enables watching of received broadcast programs in a monitor apparatus 108. In addition, the server 103 may be managed in the home of a user of the mobile terminal 102, or managed in an office of a provider that provides the broadcast play system.

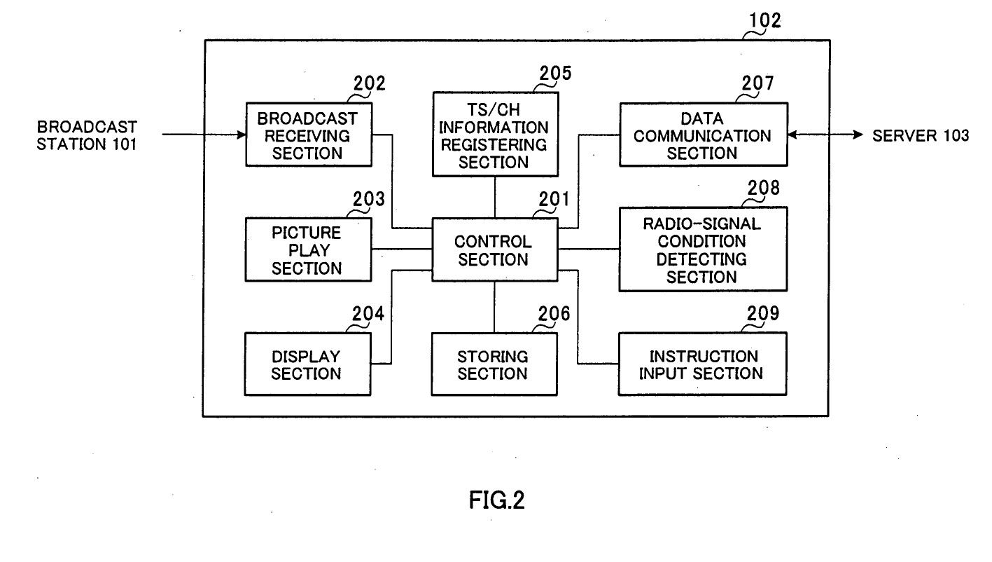

FIG. 2 is a diagram illustrating a schematic configuration of the mobile terminal 102 according to the first embodiment of the invention. In addition, the configuration as shown in FIG. 2 is simplified to explain the invention, and assumed to have structural elements installed in a typical mobile terminal.

The mobile terminal 102 has a control section 201 that controls the entire terminal, and the control section 201 is connected to a broadcast receiving section 202, picture play section 203 and display section 204. The broadcast receiving section 202 receives a broadcast program distributed from the broadcast station 101. The picture play section 203 plays pictures received from the broadcast receiving section 202 and data communication section 207 described later. The display section 204 is comprised of a liquid crystal display, for example, and displays pictures instructed to play from the picture play section 203 and operational screens such as an instruction input screen and the like.

The control section 201 is further connected to a time stamp/channel information registering section (hereinafter, a “TS/CH information registering section”) 205 and storing section 206. The TS/CH information registering section 205 designates the TS information and CH information corresponding to a detection result of a condition of a radio signal by a radio-signal condition detecting section 208 described later or a description of an instruction input received in an instruction input section 209 to register with the storing section 206. The storing section 206 stores the TS information and CH information (hereinafter, referred to as “TS/CH information” as appropriate) designated by the TS/CH information registering section 205, for example. In addition, the TS information stored in the storing section 206 is comprised of start time information (start time stamp information: start TS information) and termination time information (termination time stamp information: termination TS information).

The control section 201 is further connected to the data communication section 207, radio-signal condition detecting section 208 and instruction input section 209. The data communication section 207 performs communication processing with the server 103. For example, the section 207 performs communication processing required in transmitting the TS/CH information stored in the storing section 206 to the server 103, requesting the TS list to the server 103, receiving pictures of a broadcast program of which watching is interrupted and the like. The radio-signal condition detecting section 208 detects a condition of a radio signal transmitted from the broadcast station 101. More specifically, the section 208 detects whether the condition of the radio signal is of out of the zone or within the zone. The instruction input section 209 receives an instruction input from a user of the mobile terminal 102. For example, the instruction input section 209 receives a temporary interruption instruction for watching of the broadcast program being played. In addition, in this embodiment, the instruction input section 209 is assumed to have a button (hereinafter, referred to as a “record button”) for use in instructing a temporary interruption of watching of a broadcast program.

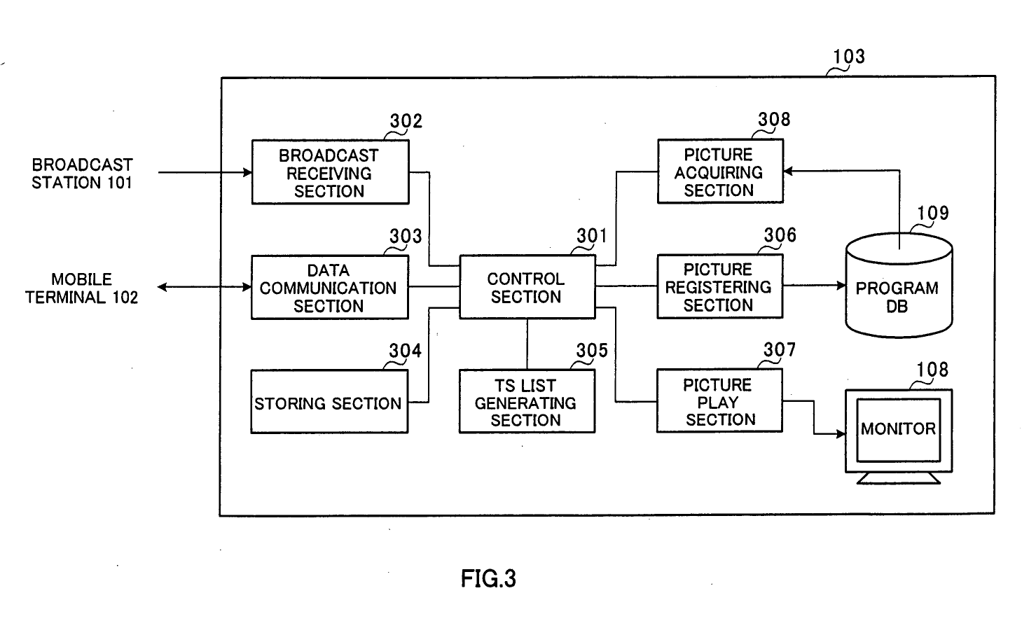

FIG. 3 is a diagram illustrating a schematic configuration of the server 103 according to the first embodiment of the invention.

The server 103 has a control section 301 that controls the entire apparatus, and the control section 301 is connected to a broadcast receiving section 302, data communication section 303 and storing section 304. The broadcast receiving section 302 receives a broadcast program distributed from the broadcast station 101. The data communication section 303 performs communication processing with the mobile terminal 102. For example, the section 303 performs communication processing required in receiving the TS/CH information from the mobile terminal 102, transmitting the TS list to the mobile terminal 102 corresponding to a TS list request from the mobile terminal 102, transmitting pictures of a broadcast program of which watching is interrupted to the mobile terminal 102, and the like. The storing section 304 stores the TS/CH information received in the data communication section 303 from the mobile terminal 102, for example. In the storing section 304, the TS/CH information is registered in association with identification information of the mobile terminal 102. In this embodiment, a case is described of using a telephone number as the identification information of the mobile terminal 102, but the type of the identification information is capable of being changed as appropriate, and for example, a serial number of the mobile terminal 102 may be used.

The control section 301 is further connected to a time stamp list generating section (hereinafter, referred to as a “TS list generating section”) 305. The TS list generating section 305 generates the TS list using the TS/CH information stored in the storing section 304. The TS list generating section 305 generates the TS list, for example, when the data communication section 303 receives a request for the TS list.

The control section 301 is further connected to a picture registering section 306, picture play section 307 and picture acquiring section 308. The picture registering section 306 registers pictures of a broadcast program received in the broadcast receiving section 302 with the program DB 109. The picture play section 307 plays pictures of a broadcast program received in the broadcast receiving section 302 in the monitor 108. The picture acquiring section 308 acquires pictures of a broadcast program registered with the program DB 109. More specifically, the section 308 acquires from the program DB 109 pictures of the broadcast program designated from the mobile terminal 102 via the data communication section 303.

In the broadcast play system according to the first embodiment, in the mobile terminal 102 and server 103 each with the above-mentioned configuration, play (watching) of a broadcast program received from the broadcast station 101 is temporarily interrupted, and the interrupted portion can be played later in the mobile terminal 102. At this point, the mobile terminal 102 registers the start TS information, termination TS information and CH information in interrupting watching of the program, while transmitting these pieces of information to the server 103. Then, the mobile terminal 102 receives a TS list generated based on the pieces of information in the server 103, selects the TS/CH information corresponding to the desired broadcast program from the TS list, thereby receives pictures of the broadcast program from the server 103, and plays the pictures.

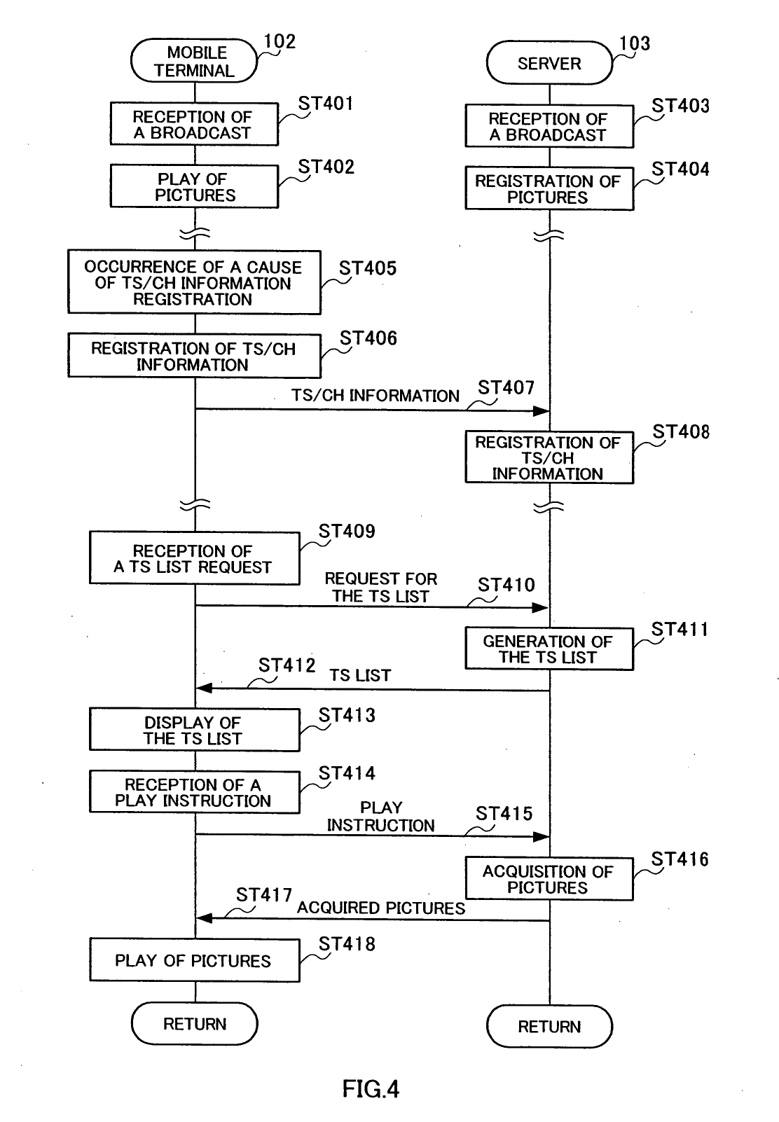

Described below is operation when watching of a broadcast program received from the broadcast station 101 is temporarily interrupted, and the interrupted portion is played later in the mobile terminal 102 in the broadcast play system according to the first embodiment. FIG. 4 is a sequence diagram to explain the operation in the case of temporarily interrupting watching of a broadcast program received from the broadcast station 101 and playing the interrupted portion later in the mobile terminal 102 in the broadcast play system according to the first embodiment.

As shown in FIG. 4, when a broadcast program is distributed from the broadcast station 101, in the mobile terminal 102, the broadcast receiving section 202 receives the broadcast program (step (hereinafter, abbreviated as “ST”) 401). Then, the picture play section 203 plays pictures of the received broadcast program (ST402). By this means, the user is capable of watching the broadcast program distributed from the broadcast station 101 in the mobile terminal 102.

Meanwhile, when a broadcast program is distributed from the broadcast station 101, in the server 103, the broadcast receiving section 302 receives the broadcast program (ST403). Then, the picture registering section 306 registers pictures of the received broadcast program with the program DB 109. By this means, with the program DB 109 are registered pictures of all the broadcast programs distributed from the broadcast station 101. In addition, the server 103 is capable of playing received broadcast programs in the picture play section 307, but descriptions thereof are omitted herein.

While pictures of the broadcast program are played in the mobile terminal 102 and the server 103 registers pictures of the broadcast program, when a cause of registration of the TS/CH information occurs such as pressing of the record button by the user, detection of the out-of-zone of the radio-signal condition by the radio-signal condition detecting section 208, or the like (ST405), the TS/CH information registering section 205 registers the TS/CH information with the storing section 206 (ST406). Subsequently, the data communication section 207 transmits the TS/CH information registered with the storing section 206 to the server 103 (ST407). In addition, details will be described below on registration of the TS/CH information due to the occurrence of a cause of registration of the TS/CH information in the mobile terminal 102 and transmission to the server 103.

In addition, the transmission timing of the TS/CH information registered with the storing section 206 to the server 103 is capable of being modified as appropriate. For example, the information may be transmitted according to a value of a timer managed in the mobile terminal 102 or server 103, or transmitted corresponding to operation by the user of the mobile terminal 102.

Upon receiving the TS/CH information from the mobile terminal 102, the server 103 registers the TS/CH information with the storing section 304 (ST408). Thus, whenever a cause of registration of the TS/CH information occurs in the mobile terminal 102, the TS/CH information is transmitted to the server 103 from the mobile terminal 102, and registered with the storing section 304.

For example, as shown in FIG. 5, the TS/CH information is registered with the storing section 304 in the server 103. FIG. 5 is a table showing an example of the TS/CH information registered with the storing section 304 of the server 103. In addition, FIG. 5 shows a case of registering a telephone number of “090-xxxx-yyyyy” as the identification information of the mobile terminal 102.

As shown in FIG. 5, with the storing section 304 of the server 103 are registered a stored date of the TS/CH information, start time information (start TS information) termination time information (termination TS information), and channel information (CH information) in association with the identification information (terminal identification information) of the mobile terminal 102. In FIG. 5, four pieces of TS/CH information are registered with the stored date of “March 31”, and five pieces of TS/CH information are registered with the stored date of “April 1”. For example, it is understood that watching of the broadcast program broadcast on 8 channel was interrupted for twelve minutes from 10:00 on March 31.

In ST408, for a period during which the TS/CH information is registered with the storing section 304 or the processing of ST401 to S407 is repeated, when the mobile terminal 102 receives an instruction input for requesting a TS list using the instruction input section 209 (ST409), the data communication section 207 transmits a command for requesting the TS list to the server 103 (ST410).

Upon receiving the request for the TS list from the mobile terminal 102, in the server 103, the TS list generating section 305 generates the TS list based on the TS/CH information in the storing section 304 (ST411). Then, the data communication section 303 transmits the generated TS list to the mobile terminal 102 (ST412).

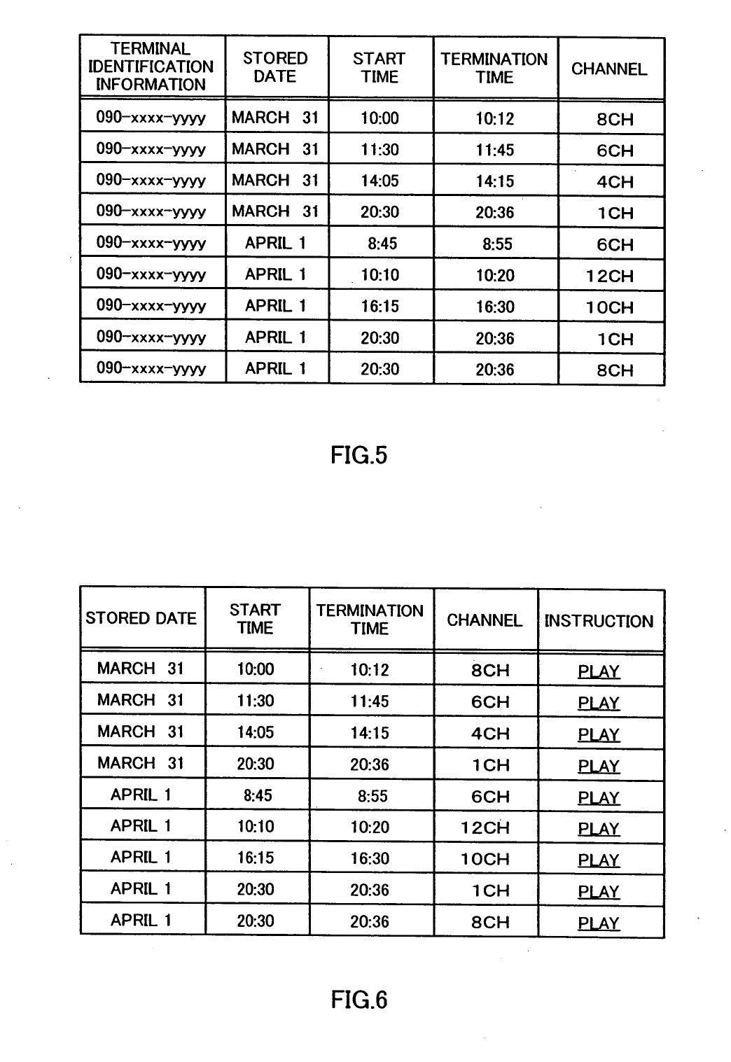

Upon receiving the TS list from the server 103, in the mobile terminal 102, the display section 204 displays the TS list (ST413). For example, the display section 204 displays the TS list as shown in FIG. 6. FIG. 6 is a table showing an example of the TS list displayed in the display section 204 of the mobile terminal 102. In addition, FIG. 6 shows a case of generating the TS list based on the TS/CH information as shown in FIG. 5.

As shown in FIG. 6, with the TS list are registered the stored date of the TS/CH information, start time information (start TS information), termination time information (termination TS information), channel information (CH information) and an instruction description received from the user. In FIG. 6, as in FIG. 5, four pieces of TS/CH information are registered with the stored date of “March 31”, and five pieces of TS/CH information are registered with the stored date of “April 1”. In addition, herein, only the case is shown that “play” is designated as the instruction description, but the instruction description is not limited thereto, and other instruction descriptions, for example, “delete” and the like may be designated.

In ST413, after the display section 204 displays the TS list, when a play instruction is received from the user based on the TS/CH information in the TS list (S414), the data communication section 207 transmits a command for instructing a play of pictures of the broadcast program corresponding to the TS/CH information to the server 103 (ST415).

Upon receiving the play instruction for pictures of the broadcast program corresponding to the TS/CH information from the mobile terminal 102, in the server 103, the picture acquiring section 308 acquires the pictures of the broadcast program corresponding to the TS/CH information from the program DB 109 (ST416). For example, in the case of receiving the play instruction for pictures of the broadcast program corresponding to the TS/CH information in the top row as shown in FIG. 6, the picture acquiring section 308 fetches pictures between “10:00” that is the start time and “10:12” that is the termination time among broadcast programs of “8 CH” on March 31 that is the stored date, and thereby, acquires the pictures of the broadcast program corresponding to the TS/CH information. Then, the data communication section 303 transmits thus obtained pictures of the broadcast program to the mobile terminal 102 (ST417).

Upon receiving the pictures of the broadcast program from the server 103, in the mobile terminal 102, the picture play section 203 plays the pictures of the broadcast program (ST418). Thus, a series of operation is finished when watching of a broadcast program received from the broadcast station 101 is temporarily interrupted, and the interrupted portion is played later in the mobile terminal 102.

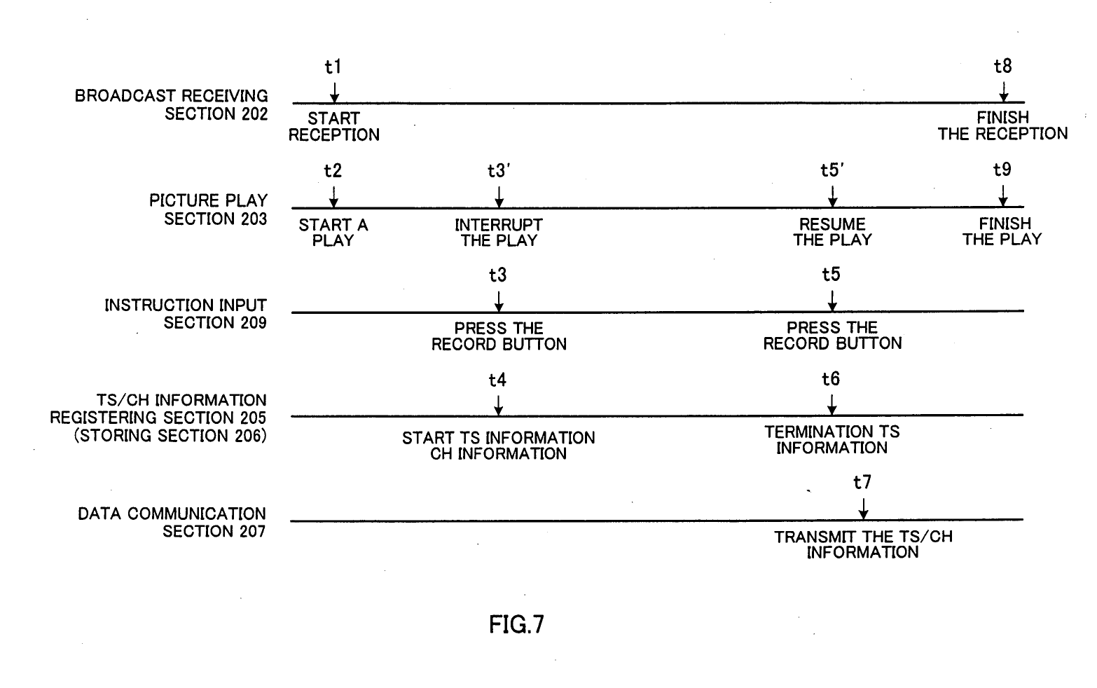

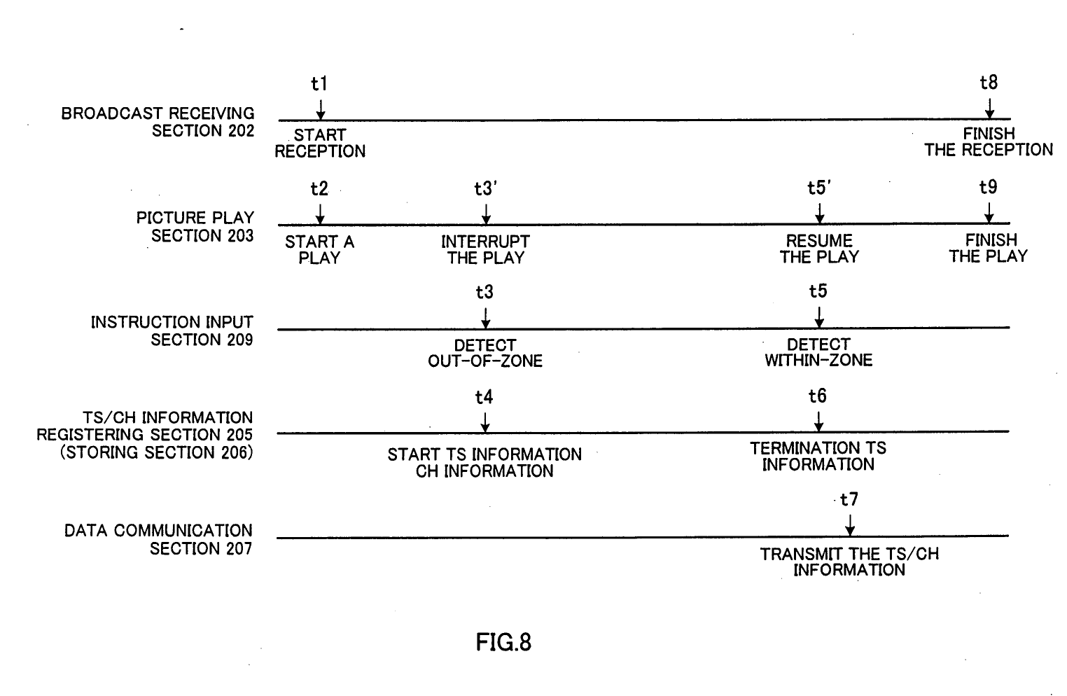

Described herein is operation timing of each structural element in the case of temporarily interrupting watching of a broadcast program in the mobile terminal 102 that performs the above-mentioned operation. FIG. 7 and FIG. 8 are diagrams to explain the operation timing of each structural element in the case of temporarily interrupting watching of a broadcast program in the mobile terminal 102. In addition, FIG. 7 shows the case that an interruption of watching of the program is instructed by the instruction input section 209, while FIG. 8 shows the case that an interruption of watching of the program is instructed corresponding to the content of a detection result by the radio-signal condition detecting section 208.

As shown in FIG. 7, when the broadcast receiving section 202 starts to receive a broadcast program distributed from the broadcast station 101 at time t1, in response thereto, the picture play section 203 starts to play pictures of the broadcast program at time t2. By this means, it is possible to watch the broadcast program distributed from the broadcast station 101 in the mobile terminal 102.

For a period during which the broadcast program is thus watched in the mobile terminal 102, when the user desires to halt watching of the broadcast program and presses the record button from the instruction input section 209 at time t3, in response thereto, at time t4, the TS/CH information registering section 205 registers the time information as the start TS information, and the channel being watched at this time as the CH information.

Then, when the user presses the record button again from the instruction input section 209 at time t5 after the cause of a temporary halt of watching of the broadcast program is dissolved, in response thereto, at time t6, the TS/CH information registering section 205 registers the time information as the termination TS information. When the registration of the termination TS information is completed, at time t7, the data communication section 207 transmits the TS/CH information to the server 103.

Then, when reception of the broadcast program from the broadcast station 101 is finished at time t8, in response thereto, the play of pictures of the broadcast program is finished at time t9. Thus, the TS/CH information is registered corresponding to an instruction input of the user during watching of the broadcast program, while being transmitted to the server 103. In addition, the example as shown in FIG. 7 indicates the case that the play of pictures of the broadcast program by the picture play section 203 is halted from time 3′ corresponding to time t3, and the play of pictures of the broadcast program is resumed at time t5′ corresponding to time t5.

Meanwhile, the case of instructing a halt of the broadcast program corresponding to the content of a detection result by the radio-signal condition detecting section 208 differs from the case as shown in FIG. 7 in respects that, as shown in FIG. 8, when the radio-signal condition detecting section 208 detects out-of-zone at time t3, in response thereto, at time t4, the TS/CH information registering section 205 registers the time information as the start TS information, and the channel being watched at this time as the CH information, and that when the radio-signal condition detecting section 208 detects return to within the zone at time t5, in response thereto, the TS/CH information registering section 205 registers the time information as the termination TS information at time t6. In this case, the TS/CH information is registered corresponding to the condition of the broadcast radio signal during watching of the broadcast program, while being transmitted to the server 103.

As shown in FIG. 7 or FIG. 8, when the data communication section 207 transmits the TS/CH information to the server 103, for example, the TS/CH information as shown in FIG. 5 is registered with the storing section 304 of the server 103. Then, by procedures as shown in ST409 to ST418 in FIG. 4, the pictures of the portion where watching of the program is halted are displayed in the mobile terminal 102.

Thus, according to the broadcast play system according to the first embodiment, when a play of pictures of a broadcast program is interrupted, the TS/CH information is transmitted to the server 103, and the server 103 generates a TS list based on the TS/CH information to transmit to the mobile terminal 102. When receiving selection of a broadcast program that the user desires to play among the TS list, a play of the broadcast program is requested to the server 103, and pictures of the broadcast program transmitted from the server 103 corresponding to the play request are played in the mobile terminal 102. Therefore, since pictures of the broadcast program are transmitted corresponding to the timing at which the user selects the broadcast program from the TS list, the user is allowed to watch the pictures of the broadcast program that the user desires, without inhibiting which watching of a currently watched broadcast program. Further, since only the pictures of the broadcast program selected from the TS list are transmitted from the server 103, it is possible to transmit the pictures of the broadcast program that the user desires, while reducing loads on the server 103. Furthermore, since reasons for an interruption of a broadcast program are not limited to reasons caused by conditions of broadcast radio signals, a user is allowed to watch pictures of the broadcast program that the user desires among pictures of the broadcast program of which watching is interrupted corresponding to any interruption reason.

In particular, in the broadcast play system according to the first embodiment, the mobile terminal 102 has the instruction input section 209 that receives an interruption instruction for the play of the broadcast program, and transmits the TS/CH information to the server 103 when receiving the interruption instruction for watching of the broadcast program via the instruction input section 209. By this means, the TS/CH information is transmitted to the server 103 corresponding to the interruption instruction for watching of the broadcast program from the user, the TS list is generated based on the TS/CH information, and it is thereby possible to interrupt watching of the program at timing desired by a user of the mobile terminal 102, and watch pictures of the interrupted broadcast program later.

Further, in the broadcast play system according to the first embodiment, the mobile terminal 102 has the radio-signal condition detecting section 208 that detects a condition of a radio signal from a broadcast station, and transmits the TS/CH information to the server 103 corresponding to a detection result of the condition of the radio signal by the radio-signal condition detecting section 208. By this means, the TS/CH information is transmitted to the server 103 corresponding to the detection result of the condition of the radio signal (for example, out of the zone or within the zone), the TS list is generated based on the TS/CH information, and it is thereby possible to watch pictures of the interrupted broadcast program later even when watching of the program is interrupted corresponding to the condition of the broadcast radio signal.

In addition, in the broadcast play system according to the first embodiment, the TS information is formed of start TS information to start an interruption of watching of the broadcast program and termination TS information to terminate the interruption of watching of the broadcast program. By forming the TS information using the start TS information and termination TS information, the broadcast program such that watching of the program is interrupted is specified from the start TS information and termination TS information, and it is thereby possible to specify the broadcast program with ease.

In addition, the present invention is not limited to the above-mentioned embodiment, and is capable of being carried into practice with various modifications thereof within the scope of exhibiting the effect of the invention. Further, the invention is capable of being carried into practice with appropriate modifications thereof without departing from the scope of the object of the invention.

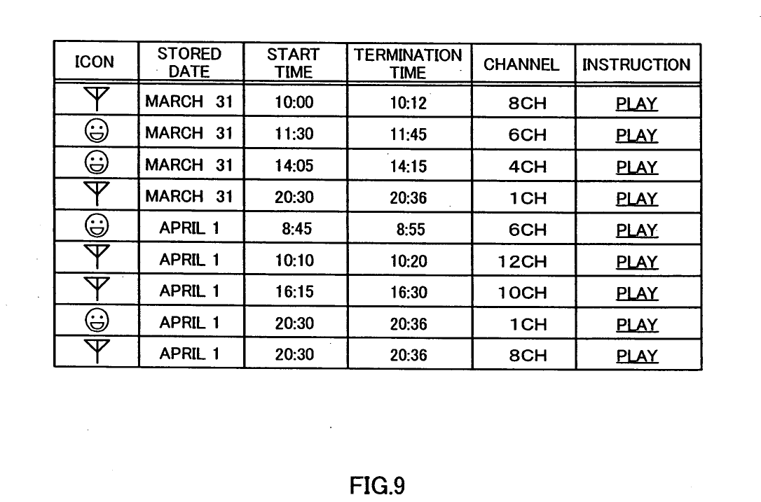

For example, in the broadcast play system according to the first embodiment, it is preferable as an embodiment that a reason for an interruption of watching of the program is described in the TS list transmitted to the mobile terminal 102 from the server 103. For example, as shown in FIG. 9, the content of the reason may be displayed such as detection of out-of-zone by the radio-signal condition detecting section 208 or an interruption instruction for watching of a broadcast program by the user. In FIG. 9, the former reason is shown by an icon of an antenna representing the out-of-zone, while the latter reason is shown by an icon representing a human face. Herein, the reasons are shown by icons, but may be shown by textual information.

In the case of such a modification, when a user selects a desired broadcast program from the TS list, the user is provided with information to assist the selection operation, and capable of selecting the desired broadcast program more easily.

Further, in the broadcast play system according to the first embodiment, the TS/CH information can be registered corresponding to a detection result of the radio-signal condition detecting section 208. However, in this case, a number of pieces of TS/CH information are registered when the condition of the broadcast radio signal is varied intermittently, and it may be difficult to specify a broadcast program that the user desires to play later. In order to avoid such a situation, it is preferable as an embodiment that control is made so that the termination TS information is registered only when a predetermined time (for example, one minute) has elapsed since the terminal returns to inside the zone from outside the zone. Described herein is a case of controlling registration of the termination TS information with the predetermined time assumed to be a minute.

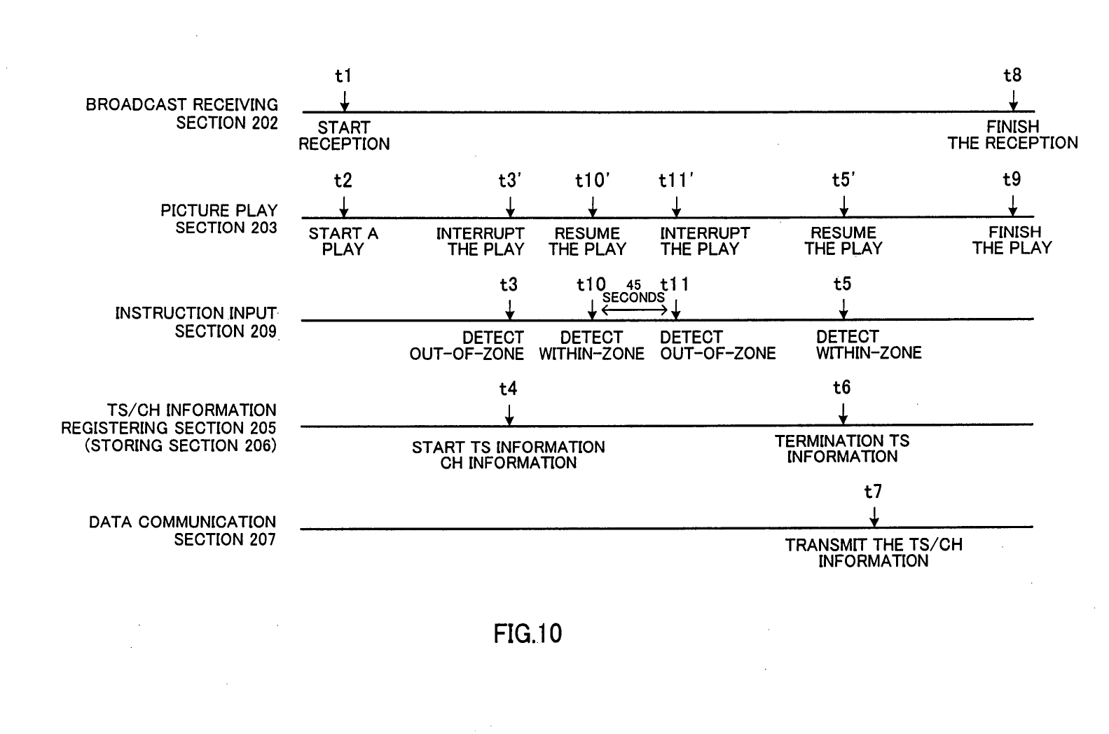

FIG. 10 is a diagram to explain operation timing of each structural element in the case of temporarily interrupting watching of a broadcast program in thus modified mobile terminal 102. In addition, as in FIG. 10, descriptions of the same content as in FIG. 5 are omitted.

In FIG. 10, a case is shown where the radio-signal condition detecting section 208 detects out-of-zone at time t3, then detects return to inside the zone at time t10, and further detects out-of-zone again at time t11. Herein, only forty-five seconds have elapsed at time t11 since time t10. Therefore, the TS/CH information registering section 205 does not register the termination TS information at the time corresponding to time t10. In addition, FIG. 10 shows the case that since the shift to outside the zone is not detected for one minute or more at time t5 after return to inside the zone is detected, the termination TS information is registered at time t6 corresponding to time t5.

In the case of such a modification, in interrupting watching of a broadcast program corresponding to a detection result of the radio-signal condition detecting section 208, even when the condition of the radio signal varies intermittently, the situation is avoided that a number of pieces of TS/CH information are registered, and it is thus possible to prevent the occurance of a situation that the user becomes difficult to later specify a broadcast program that the user wants to play.

Further, in the broadcast play system according to the first embodiment, the TS/CH information can be registered corresponding to a corresponding result of the radio-signal condition detecting section 208. However, when the start TS information and CH information is registered corresponding to a shift to outside the zone and then the user changes the channel, such a situation may occur that a broadcast program that the user wants to play later is different from a desired broadcast program.

Therefore, in the mobile terminal 102 according to the first embodiment, when the channel is changed after moving to outside the zone, TS/CH information corresponding to channels prior and subsequent to the change is registered, and transmitted to the server 103. In FIG. 6, the TS/CH information in two lowest rows corresponds to thus registered TS/CH information. In other words, the TS/CH information with “ICH” designated as the CH information prior to a change is registered (second lowest row), while the TS/CH information with “8CH” designated as the CH information subsequent to the change is registered (lowest row).

In the case of such a modification, even when the start TS information and CH information is registered corresponding to a shift to outside the zone and then the user changes the channel, the TS/CH information corresponding to channels prior and subsequent to the change is registered, and it is thus possible to prevent the occurrence of the situation that a broadcast program that the user wants to play later is different from a desired broadcast program.

### Embodiment 2

In the broadcast play system according to the first embodiment, registration of the TS/CH information is determined corresponding to detection of a status of out-of-zone by the radio-signal condition detecting section 208 or interruption instruction for watching of a broadcast program by a user using the instruction input section 209, but determination of registration of the TS/CH information is not limited thereto, and is capable of being modified on the assumption of ensuring user convenience.

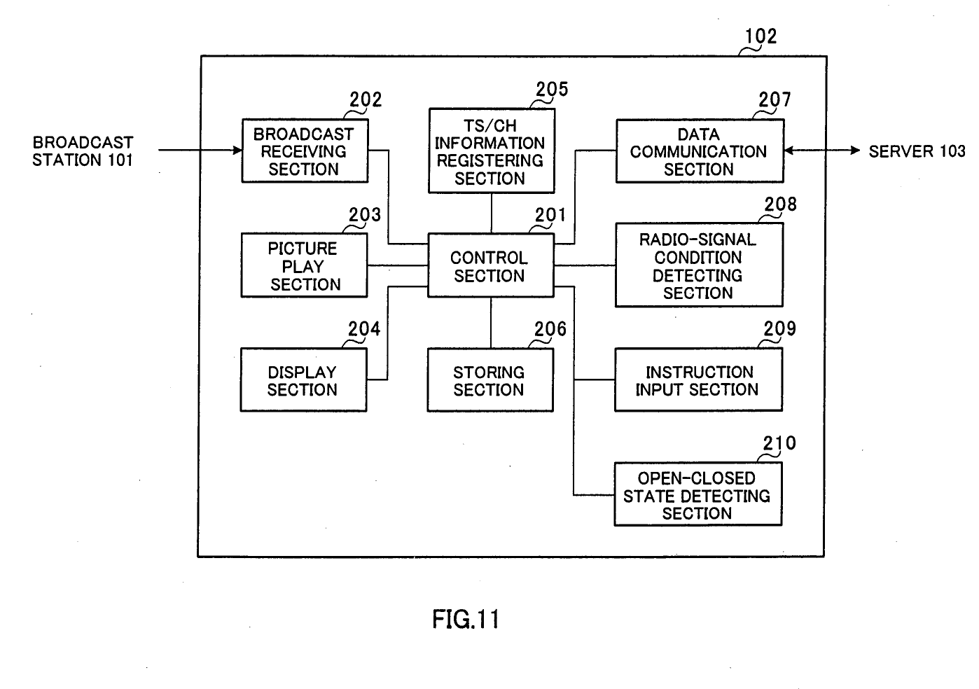

As shown in FIG. 11, a broadcast play system according to the second embodiment of the invention differs from the broadcast play system according to the first embodiment in a respect that the mobile terminal 102 has an open/closed state detecting section 210 that monitors an open/closed state of the mobile terminal 102. The open/closed state detecting section 210 detects a state (open state) where the mobile terminal 102 is opened or another state (closed state) where the mobile terminal 102 is closed. Such an open/closed state detecting section 210 is provided, and in the broadcast play system according to the second embodiment, registration of the TS/CH information is determined corresponding to the open/closed state of the mobile terminal 102.

In addition, FIG. 11 shows the case of providing the open/closed state detecting section 210 as well as structural elements of the mobile terminal 102 according to the first embodiment, but the invention is not limited thereto. The section 210 may be replaced with one or both of the radio-signal condition detecting section 208 and instruction input section 209.

Also in the broadcast play system according to the second embodiment, the operation in the case of temporarily interrupting watching of a broadcast program received from the broadcast station 101 and playing the interrupted portion later in the mobile terminal 102 is the same as in the broadcast play system according to the first embodiment, and specific descriptions thereof are omitted (see FIG. 7). The broadcast play system according to the second embodiment differs from the broadcast play system according to the first embodiment in a respect that a reason for registration of the TS/CH information in the mobile terminal 102 is based on a detection result of the open/closed state detecting section 210.

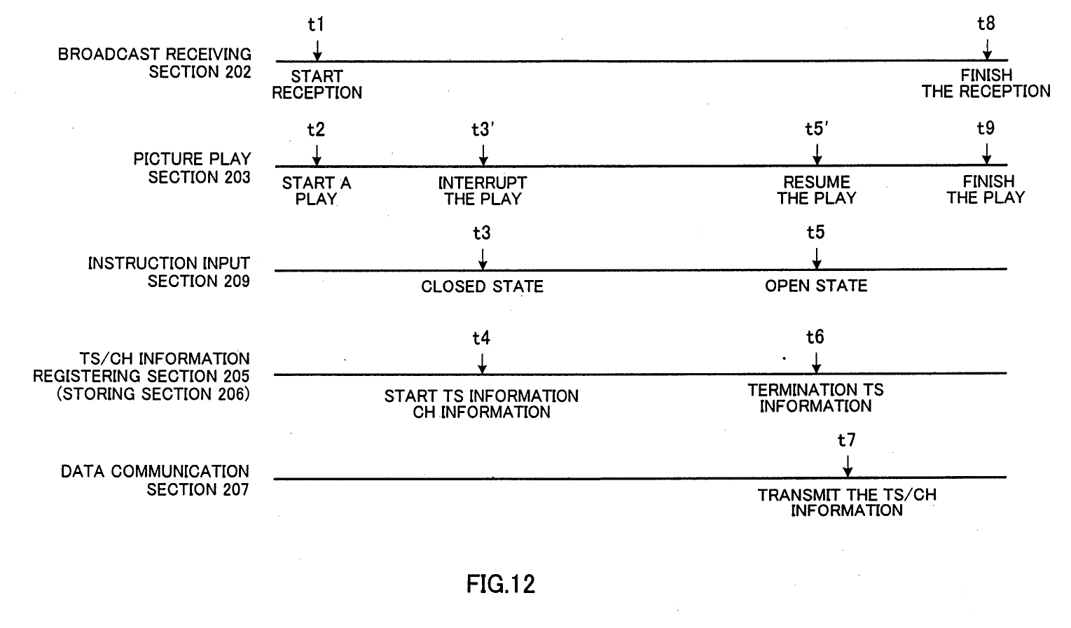

FIG. 12 is a diagram to explain operation timing of each structural element in the case of temporarily interrupting watching of a broadcast program in the mobile terminal 102 in the second embodiment. In particular, FIG. 12 shows the case of registering the TS/CH information corresponding to a detection result of the open/closed state detecting section 210. In addition, in FIG. 12, descriptions are omitted on the same content as in FIG. 7.

The case of registering the TS/CH information corresponding to a detection result of the open/closed state detecting section 210 differs from the case as shown in FIG. 7 in respects that, as shown in FIG. 12, when the open/closed state detecting section 210 detects the closed state at time t3, in response thereto, at time t4, the time information is registered as the start TS information, while the channel being watched at this time is registered as the CH information, and that when the open-close state detecting section 210 detects the open state at time t5, in response thereto, the time information is registered as the termination TS information at time t6. In this case, the TS/CH information is registered corresponding to the open/closed state of the mobile terminal 102 during watching of a broadcast program, while being transmitted to the server 103.

Thus, according to the broadcast play system according to the second embodiment, since the TS/CH information is registered corresponding to the open/closed state of the mobile terminal 102, while being transmitted to the server 103, it is possible to judge an interruption of watching of the program corresponding to the open/closed state of the mobile terminal 102 and generate a TS list corresponding to the judgment.

### Embodiment 3

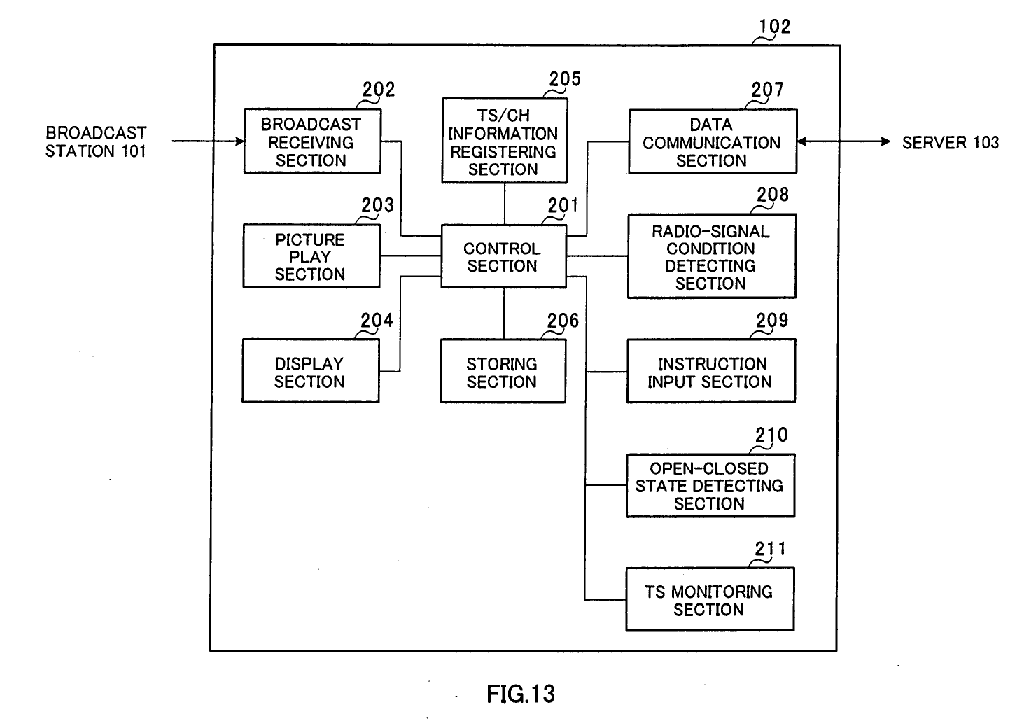

As shown in FIG. 13, a broadcast play system according to the third embodiment of the invention differs from the broadcast play system according to the second embodiment in a respect that the mobile terminal 102 has a time stamp monitoring section (hereinafter, referred to as a “TS monitoring section”) 211 that monitors a status of the TS information. The TS monitoring section 211 monitors whether or not the termination TS information is registered within a predetermined time after the start TS information is registered by a cause of occurrence of registration of the TS/CH information. Then, when the termination TS information is not registered within a predetermined time, the section 211 notifies the TS/CH information registering section 205 of the fact, and instructs to register the termination TS information. Such a TS monitoring section 211 is provided, and in the broadcast play system according to the third embodiment, registration of the termination TS information is determined corresponding to whether or not the termination TS information is registered within a predetermined time.

In addition, FIG. 13 shows the case of providing the TS monitoring section 211 as well as structural elements of the mobile terminal 102 according to the second embodiment, but the invention is not limited thereto. Such a configuration may be provided that the TS monitoring section is combined with any one or any combination of the radio-signal condition detecting section 208, instruction input section 209 and open-closed state detecting section 210.

Also in the broadcast play system according to the third embodiment, the operation in the case of temporarily interrupting watching of a broadcast program received from the broadcast station 101 and playing the interrupted portion later in the mobile terminal 102 is the same as in the broadcast play system according to the first or second embodiment, and specific descriptions thereof are omitted (see FIG. 7). The broadcast play system according to the third embodiment differs from the broadcast play system according to the first or second embodiment in a respect that the termination TS information among the TS/CH information in the mobile terminal 102 is registered automatically when the termination TS information is not registered within a predetermined time.

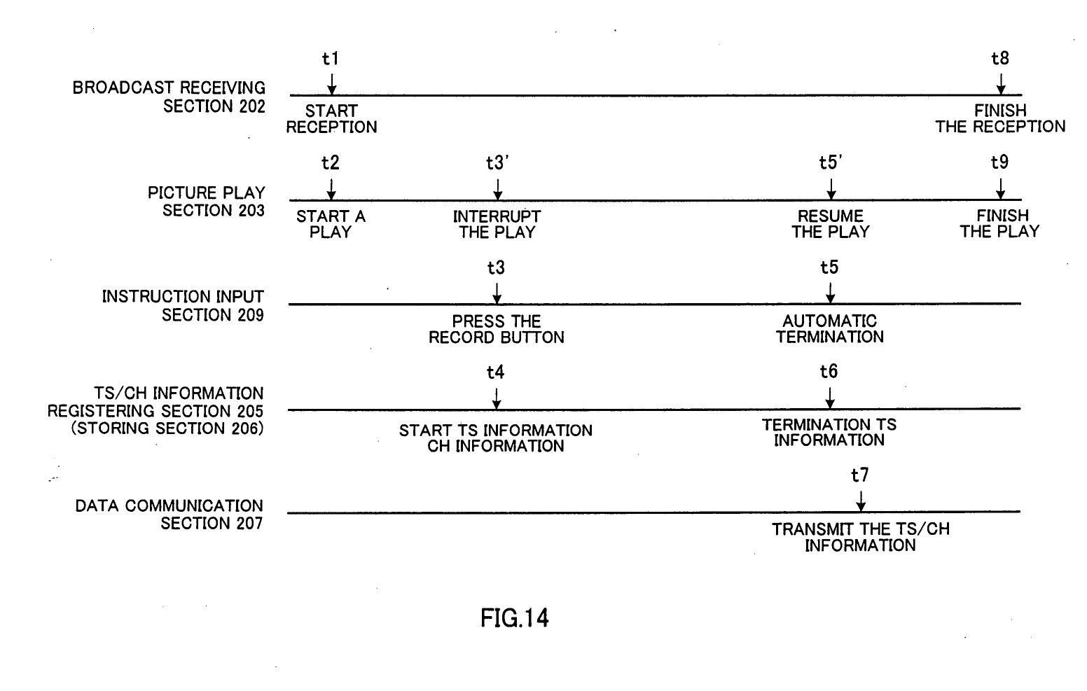

FIG. 14 is a diagram to explain operation timing of each structural element in the case of temporarily interrupting watching of a broadcast program in the mobile terminal 102 in the third embodiment. In particular, FIG. 14 shows the case of registering the termination TS information corresponding to the content of a detection result of the TS monitoring section 2 11. In addition, in FIG. 14, descriptions are omitted on the same content as in FIG. 7.

In the case of registering the termination TS information corresponding to the content of a detection result of the TS monitoring section 211, as shown in FIG. 14, at time t4, the TS/CH information registering section 205 registers the time information as the start TS information, and the channel being watched at this time as the CH information, and then, the TS monitoring section 211 determines whether the termination TS information is registered within a predetermined time (for example, five minutes). Herein, it is assumed that the termination TS information is not registered within a predetermined time. In this case, at time t5 when the predetermined time has elapsed since time t3, the TS monitoring section 211 notifies the fact to the TS/CH registering section 205, and in response thereto, the TS/CH information registering section 205 registers the time information as the termination TS information at time t6. In this case, when the termination TS information is not registered within a predetermined time after the start TS information is registered, the termination TS information is automatically registered, while the TS/CH information is transmitted to the server 103.

Thus, according to the broadcast play system according to the third embodiment, when the termination TS information is not registered within a predetermined time after the start TS information is registered, the termination TS information is automatically registered, while the TS/CH information is transmitted to the server 103. Therefore, for example, when a user forgets to release an interruption after instructing the interruption of watching of the program, it is possible to prevent the occurrence of continuation of the interruption of watching of the program.

In addition, in the broadcast play system according to the third embodiment, as shown in FIG. 14, the case is described that the start TS information and CH information is registered corresponding to an interruption instruction for watching of a broadcast program from a user, but is shown as an example of a cause of registration of the TS/CH information. The invention is applicable to the case of registering the TS/CH information corresponding to a detection result of the radio-signal condition detecting section 208 or open-closed state detecting section 211.

What is claimed is:

1. A mobile terminal apparatus connected via a communication channel to a server apparatus that stores pictures of a broadcast program distributed from a broadcast station, comprising:
a broadcast receiving section that receives a broadcast program distributed from a broadcast station;
a picture play section that plays pictures of the broadcast program; and
a communication section that communicates with the server apparatus via the communication channel,
wherein when a play of pictures of the broadcast program is interrupted, the mobile terminal apparatus transmits interruption time information and program specific information to the server apparatus, receives a play interruption program list generated based on the interruption time information and the program specific information, requests a play of the broadcast program to the server apparatus when receiving selection of the broadcast program of which play is desired among the play interruption program list, and plays in the picture play section pictures of the broadcast program transmitted from the server apparatus corresponding to the play request.

2. The mobile terminal apparatus according to claim 1, further comprising:
an instruction input section that receives an interruption instruction for the play of the broadcast program,
wherein the mobile terminal apparatus transmits the interruption time information and the program specific information to the server apparatus when receiving the interruption instruction for the play of the broadcast program via the instruction input section.

3. The mobile terminal apparatus according to claim 1, further comprising:
a radio-signal condition detecting section that detects a condition of a radio signal from the broadcast station,
wherein the mobile terminal apparatus transmits the interruption time information and the program specific information to the server apparatus corresponding to a detection result of the condition of the radio signal by the radio-signal condition detecting section.

4. The mobile terminal apparatus according to claim 1, further comprising:
an open/closed state detecting section that detects an open/closed state of a main body of the terminal,
wherein the mobile terminal apparatus transmits the interruption time information and the program specific information to the server apparatus corresponding to a detection result of the open/closed state by the open/closed state detecting section.

5. The mobile terminal apparatus according to claim 1, wherein the interruption time information is formed of interruption start time information to start an interruption of the play of the broadcast program and interruption termination time information to terminate the interruption of the play of the broadcast program.

6. The mobile terminal apparatus according to claim 5, further comprising:
an elapsed time monitoring section that monitors an elapsed time between the interruption start time information and the interruption termination time information,
wherein the elapsed time monitoring section automatically designates the interruption termination time information when the elapsed time exceeds a predetermined time.

7. A server apparatus connected via a communication channel to a mobile terminal apparatus that plays pictures of a broadcast program distributed from a broadcast station, comprising:
a broadcast receiving section that receives a broadcast program distributed from the broadcast station;
a picture storing section that stores pictures of the broadcast program;
a communication section that communicates with the mobile terminal apparatus via the communication channel;
a storing section that stores interruption time information and program specific information that is transmitted when a play of pictures of the broadcast program is interrupted in the mobile terminal apparatus;
a list generating section that generates a play interruption program list based on the interruption time information and the program specific information; and
a picture acquiring section that acquires pictures of the broadcast program selected from the play interruption program list from the picture storing section,
wherein the server apparatus generates and transmits the play interruption program list corresponding to a request from the mobile-terminal apparatus, and when receiving selection of the broadcast program of which play is desired among the play interruption program list, acquires pictures of the broadcast program from the picture storing section to transmit to the mobile terminal apparatus.

8. The server apparatus according to claim 7, wherein the interruption time information is formed of interruption start time information to start an interruption of the play of the broadcast program and interruption termination time information to terminate the interruption of the play of the broadcast program, and the picture acquiring section acquires pictures of the broadcast program specified by the interruption start time information and the interruption termination time information among pictures of the broadcast program stored in the picture storing section.

9. A broadcast play system comprising:
a mobile terminal apparatus that receives a broadcast program distributed from a broadcast station while playing pictures of the broadcast program; and
a server apparatus which is connected to the mobile terminal apparatus via a communication channel, and receives a broadcast program distributed from the broadcast station while storing pictures of the broadcast program,
wherein the mobile terminal apparatus transmits interruption time information and program specific information to the server apparatus when a play of pictures of the broadcast program is interrupted, the server apparatus transmits to the mobile terminal apparatus a play interruption program list generated based on the interruption time information and the program specific information, the mobile terminal apparatus requests a play of the broadcast program to the server apparatus when receiving selection of the broadcast program of which play is desired among the play interruption program list, the server apparatus acquires pictures of the broadcast program of which play is requested from stored pictures of the broadcast program to transmit to the mobile terminal apparatus, and the mobile terminal apparatus plays the pictures of the broadcast program.
